(19) United States
(12) Patent Application Publication
(10) Pub. No.: US 2012/0025037 A1
(43) Pub. Date: Feb. 2, 2012

(54) ADJUSTABLE MULTI-SCREEN SUPPORT STRUCTURE

(76) Inventor: Chien-Kuo Chang, Taoyuan County (TW)

(21) Appl. No.: 12/845,453

(22) Filed: Jul. 28, 2010

(51) Int. Cl. F16M 11/12

(52) U.S. Cl. 248/124.1

(57) ABSTRACT

An adjustable multi-screen support structure includes a mounting unit having an upright rod at the top side of a tubular mounting base thereof and a mounting device at the bottom side of the tubular mounting base for fastening to an external object, multiple screen supports each having a coupling sleeve at the bottom side and a bracket at the top side for holding a screen, and a support holder that has a tubular holder base axially adjustably sleeved onto the upright rod of the mounting unit and locked by holding down screws and a plurality of stepped shaft members fixedly connected to the periphery of the tubular holder base for holding the coupling sleeves of the screen supports respectively.

### BACKGROUND OF THE INVENTION

1. Field of the Invention

The present invention relates to a screen support device and more particularly, to an adjustable multi-screen support structure, which comprises a mounting unit having an upright rod, a support holder vertically slidably sleeved onto the upright rod and releasably locked thereto with holding-down members, and a plurality of screen supports pivotally coupled to stepped shaft members of the support holder to hold one respective screen.

2. Description of the Related Art

When positioning a LCD monitor or LCD TV on a flat surface, for example, the top of a table or desk, a support may be used to support the LCD monitor or LCD TV on the top of the table or desk. The support is positioned on the top of the table or desk subject to the desired view angle.

When wishing to adjust the view angle of the supported LCD monitor or LCD TV, the user may have to move the LCD monitor or LCD TV away from the support and then adjust the angular position of the support. There are LCD monitors and LCD TVs that allow adjustment of the view angle. A view-angle adjustable LCD monitor or LCD TV has a swivel stand mounted on the bottom side for allowing adjustment of the view angle of the screen. However, the adjustment of the view angle of a conventional view-angle adjustable LCD monitor or LCD TV is still not very convenient. The user may have to make several trials before getting the best view angle.

There is known an adjustable screen support that allows adjustment of the position and angle of the supported screen so that the user's eyes will not get tired soon. However, this design of adjustable screen support simply allows adjustment of the angular position of the supported screen horizontally. It does not allow adjustment of the elevation of the supported screen. There is known an adjustable screen support design that uses spring means to support pivotally connected support arms, allowing adjustment of the angle of inclination of the supported screen. This adjustable screen support design is still not satisfactory in function. When a relatively heavier screen is loaded, the spring means may be unable to accurately and positively support the pivotally connected support arms in the adjusted angle of inclination. Thus, the supported screen may be biased, or may fall from the position. When enhancing the spring force of the spring means, the cost will be relatively increased.

Therefore, it is desirable to provide a screen support structure, which eliminates the aforesaid problems.

### SUMMARY OF THE INVENTION

The present invention has been accomplished under the circumstances in view. It is one object of the present invention to provide an adjustable multi-screen support structure, which is practical for supporting multiple screens on an object, allowing adjustment of the elevations and view angles of the supported screens.

To achieve this and other objects of the present invention, an adjustable multi-screen support structure is modularized, comprising a mounting unit having an upright rod at the top side multiple screen supports, one or multiple support holders axially slidably coupled to the upright rod of the mounting unit, a plurality of holding-down members, for example, holding-down screws threaded into mounting through holes on each support holder and fastened tight to lock each support holder to the upright rod of the mounting unit, and a plurality of screen supports coupled to the support holder(s) to hold one respective screen. Each screen support has a coupling sleeve disposed at the bottom side and coupled to one stepped shaft member of one support holder, and a bracket disposed at the top side for holding a screen. By means of the coupling sleeve, each screen support can be turned about the stepped shaft member of the associating support holder to adjust the view angle of the supported screen. When loosened the holding-down members, each support holder can be moved along the upright rod of the mounting unit to adjust the elevation of the supported screen(s).

Each support holder further comprises a bush inserted into the tubular holder base thereof, and a friction pad inserted into the tubular holder base and stopped between the bush and the tubular holder base for stopping the periphery of the bush against the periphery of the upright rod of the mounting unit by the holding-down members. The friction pad is prepared from metal. The bush is injection-molded from plastics. Thus, a high friction force will be produced between the friction pad and the bush when fastening tight the holding-down members, enabling the support holder to be locked to the upright rod of the mounting unit positively.

### BRIEF DESCRIPTION OF THE DRAWINGS

FIG. 1 is an elevational view of a support holder for adjustable multi-screen support structure in accordance with the present invention.

FIG. 2 is an exploded view of the support holder shown in FIG. 1.

FIG. 3 is a schematic sectional view of the support holder, showing according to the present invention.

FIG. 4 is an exploded view of an adjustable multi-screen support structure in accordance with the present invention.

FIG. 5 is a schematic drawing of the present invention, showing the adjustable multi-screen support structure installed a flat panel of an object.

FIG. 6 is a schematic drawing of the present invention, showing an alternate form of the adjustable multi-screen support structure installed a flat panel of an object.

FIG. 7 is a schematic drawing of the present invention, showing another alternate form of the adjustable multi-screen support structure installed a flat panel of an object.

FIG. 8 is an exploded view of still another alternate form of the adjustable multi-screen support structure in accordance with the present invention.

### DETAILED DESCRIPTION OF THE PREFERRED EMBODIMENT

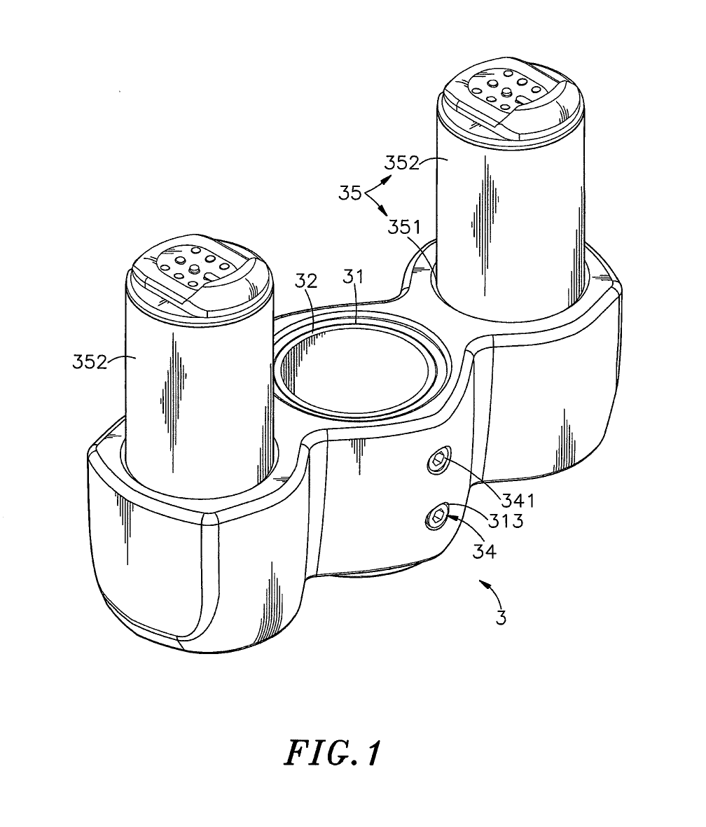

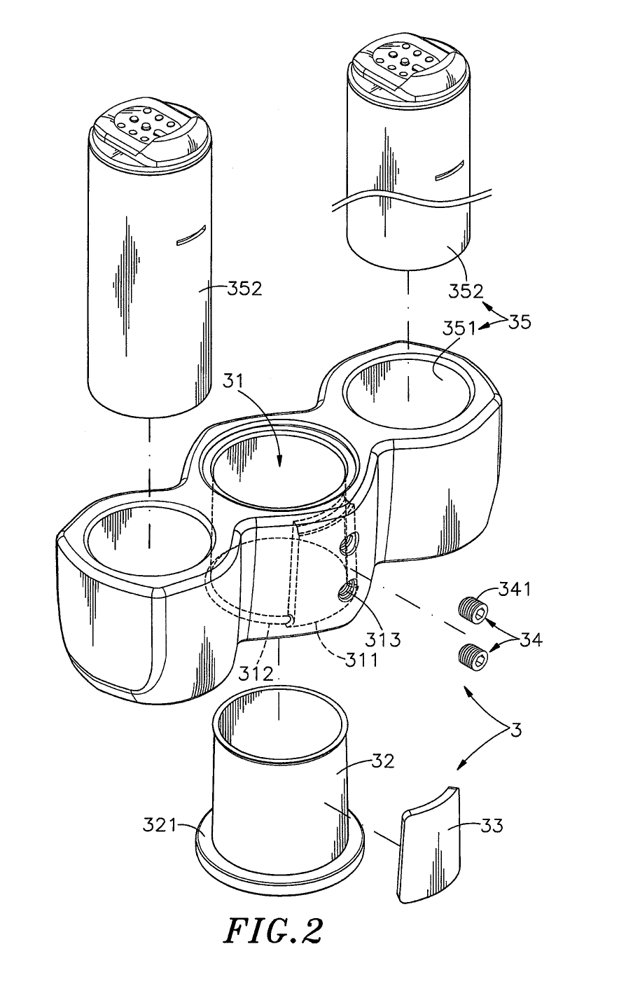

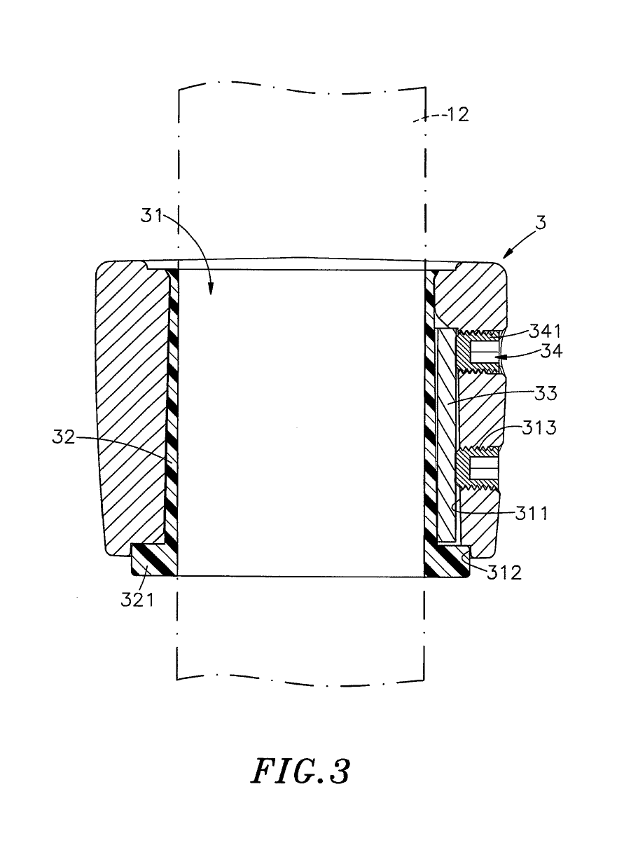

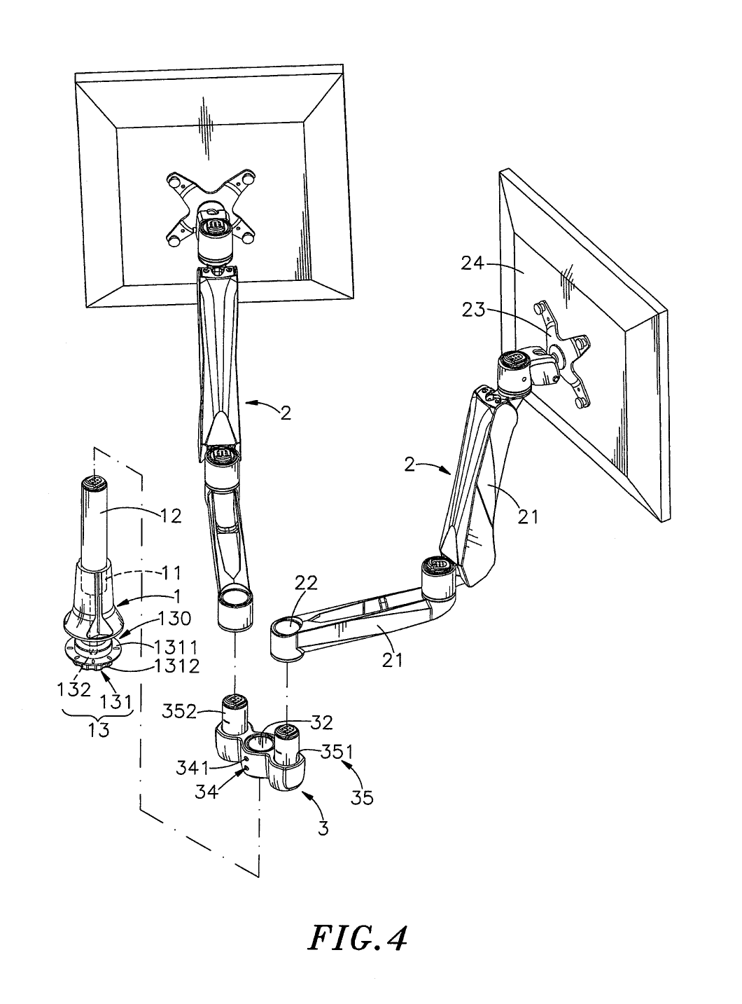

Referring to FIGS. 1-5, an adjustable multi-screen support structure in accordance with the present invention is shown comprising a plurality of a mounting unit 1, a plurality of screen supports 2 and a support holder 3.

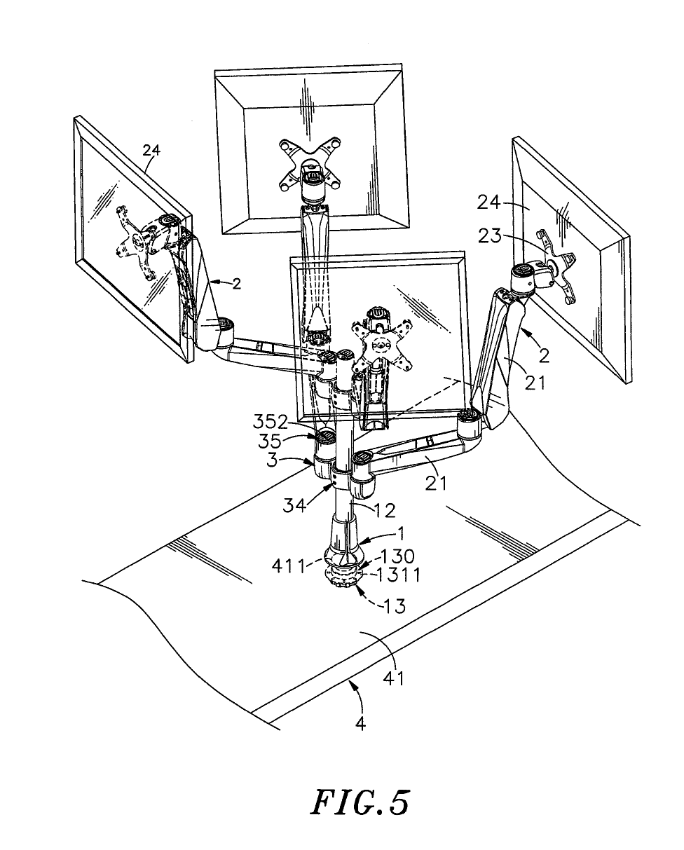

The mounting unit 1 comprises a tubular mounting base 11, an upright rod 12 vertically mounted in the top side of the tubular mounting base 11, and a mounting device 13 located on the bottom side of the tubular mounting base 11 for fastening to an object 4 (see FIG. 5).

Each screen support 2 comprises at least one, for example, two support arms 21 pivotally connected in series, a coupling sleeve 22 located on one end, namely, the bottom end of the series of support arms 21 and a bracket 23 located on the other end, namely, the top end of the series of support arms 21 and adapted for supporting a screen 24.

The support holder 3 comprises a tubular holder base 31 sleeved onto the upright rod 12 of the mounting unit 1, a locating groove 311 located on the smoothly arched inside wall of the tubular holder base 31, a positioning groove 312 located on the bottom side thereof and extending along the bottom edge of the tubular holder base 31, a plurality of mounting through holes, for example, screw holes 313 transversely extending through the peripheral wall of the tubular holder base 31 and arranged at different elevations, a bush 32 inserted into the tubular holder base 31 from the bottom side and having a bottom flange 321 extending around the periphery thereof and fitted into the positioning groove 312, a friction pad 33 set in the locating groove 311 and attached to the periphery of the bush 32, a plurality of holding-down members 34 respectively mounted in the screw holes 313 and stopped against the friction pad 33 and rotatable inwards or outwards to force the friction pad 33 against the bush 32 and the upright rod 12 of the mounting unit 1 or to release the pressure from the friction pad 33, and a plurality stepped shaft members 35 fixedly connected to the periphery of the tubular holder base 31 in a parallel manner for holding the coupling sleeves 22 of the screen supports 2. According to the present preferred embodiment, each stepped shaft member 35 comprises a cup-shaped shell 351 formed integral with the periphery of the tubular holder base 31 and adapted for supporting the coupling sleeve 22 of one screen support 2, and a shank 352 mounted in the cup-shaped shell 351 inserted through the sleeve 22 of the associating screen support 2. As an alternate form of the present invention, each stepped shaft member 35 can be a one piece member, i.e., the cup-shaped shell 351 and the shank 352 can be formed in integrity.

During installation of the present invention, insert the friction pad 33 into the locating groove 311 in the tubular holder base 31 of the support holder 3, and then insert the bush 32 into the tubular holder base 31 to force the bottom flange 321 of the bush 32 into engagement with the positioning groove 312, and then sleeve the bush 32 and the tubular holder base 31 of the support holder 3 onto the upright rod 12 of the mounting unit 1. At this time, the support holder 3 can be moved along the upright rod 12 of the mounting unit 1 to the desired elevation. Thereafter, mount the holding-down members 34 in the screw holes 313 to hold down the friction pad 33 against the bush 32 and the upright rod 12 of the mounting unit 1, locking the bush 32 and the tubular holder base 31 of the support holder 3 to the upright rod 12 of the mounting unit 1, and then couple the coupling sleeves 22 of the screen supports 2 to the shanks 352 of the stepped shaft members 35.

During application of the adjustable multi-screen support structure, as shown in FIG. 5, fasten the mounting device 13 of the mounting unit 1 to an object 4. In one embodiment of the present invention, the mounting device 13 comprises a screw rod 132 axially downwardly extended from the center of the bottom wall of the tubular mounting base 11, and a mounting plate 131 threaded onto the screw rod 132. The mounting plate 131 has a top clamping wall 1311 that define with the bottom wall of the tubular mounting base 11 a clamping space 130, and a bottom knob 1312 operable by the user to rotate the mounting plate 131 relative to the screw rod 132. During installation, insert the screw rod 132 downwardly through a mounting through hole 411 on a flat panel 41 of an object 4 (for example, the tabletop of a table) to let the bottom wall of the tubular mounting base 11 be supported on the top wall of the flat panel 41, and then thread the mounting plate 131 onto the screw rod 132 to abut the top clamping wall 1311 against the bottom wall of the flat panel 41. Thus, the flat panel 41 is engaged in the clamping space 130, and the mounting device 13 of the mounting unit 1 is locked to the object 4.

When the user pushes the support arms 21 of one screen support 2, the coupling sleeve 22 of the screen support 2 is turned about the shank 352 of the associating stepped shaft member 35, and the screen 24 that is affixed to the bracket 23 of the support arms 21 of the screen support 2 is moved to the desired angle. Thus, the user can adjust the view angle of each screen 24 conveniently with less effort.

Further, the friction pad 33 of the support holder 3 can be prepared from aluminum, ferrite or any of a variety of other metal materials; the bush 32 can be injection-molded from plastics. When forcing the metal friction pad 33 at the plastic bush 32 against the periphery of the upright rod 12 of the mounting unit 1, sufficient friction force will be produced between the plastic bush 32 and the upright rod 12, thereby locking the support holder 3 to the mounting unit 1 positively. Further, the holding-down members 34 can be hexagonal tubular mounting base screws 341 that can be driven by a hexagonal wrench into the screw holes 313 to hold down the friction pad 33 against the bush 32 and the upright rod 12 of the mounting unit 1, locking the bush 32 and the tubular holder base 31 of the support holder 3 to the upright rod 12 of the mounting unit 1. Further, any of a variety of fastening means may be used instead of the holding-down members 34 for releasably locking the tubular holder base 31 of the support holder 3 to the upright rod 12 of the mounting unit 1.

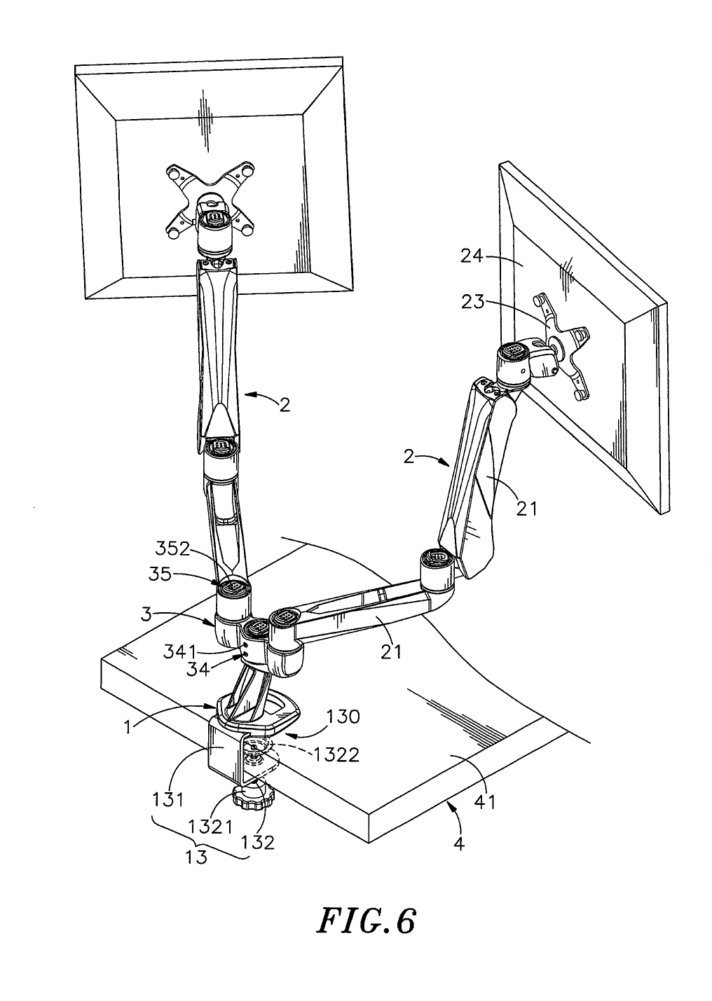

Referring to FIG. 6, in an alternate form of the present invention, the mounting device 13 comprises a mounting plate 131 made in the form of a substantially L-shaped mounting shaft and fixedly connected to the bottom wall (of the tubular mounting base) of the mounting unit 1, and a screw rod 132 made in the form of a tension clamp. The screw rod (tension clamp) 132 is threaded through the bottom wall of the mounting plate (mounting shaft) 131, having a head 1321 located on the bottom end thereof and suspending below the mounting plate (mounting shaft) 131 and a flat block 1322 located on the top end thereof and suspending in the mounting plate (mounting shaft) 131. The flat block 1322 of the screw rod (tension clamp) 132 defines with the bottom wall (of the tubular mounting base) of the mounting unit 1 a clamping space 130 for receiving a flat panel 41 of an object 4 (for example, the tabletop of a table). After the mounting plate (mounting shaft) 131 is attached with the mounting unit 1 a flat panel 41 of an object 4, rotate the head 1321 of the screw rod (tension clamp) 132 relative to the mounting plate (mounting shaft) 131 to force the flat block 1322 of the screw rod (tension clamp) 132 against the bottom wall of the flat panel 41 of the object 4, locking the mounting unit 1 to the object 4.

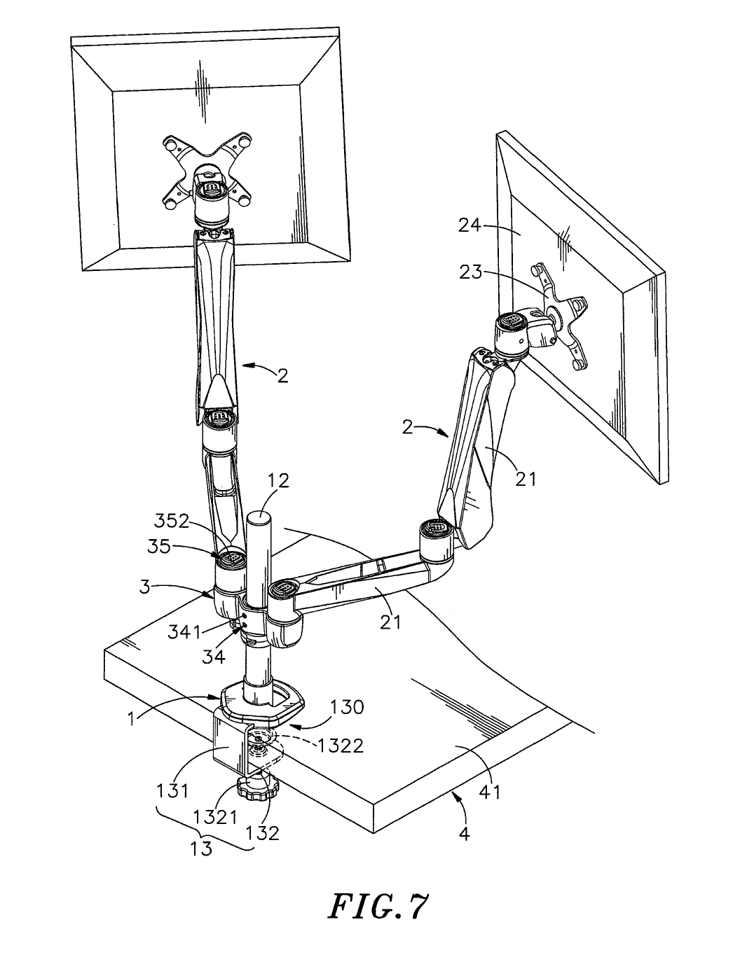

FIG. 7 illustrates another alternate form of the present invention. This embodiment is substantially similar to that shown in FIG. 6 with the exception of the configuration design of the tubular mounting base 11 of the mounting unit 1.

Referring to FIG. 5 again, multiple support holders 3 can be fastened to the upright rod 12 of the mounting unit 1 at different elevations to hold more number of screen supports 2 and screens 24. By means of loosening the holding-down members 34, the support holders 3 can be moved relative to the upright rod 12 of the mounting unit 1 to respective desired elevations. After adjustment of the elevation of each support holder 3, the holding-down members 34 are fastened tight to lock each support holder 3 to the upright rod 12 of the mounting unit 1. After installation, the user can adjust the view angle of each screen 24 conveniently with less effort.

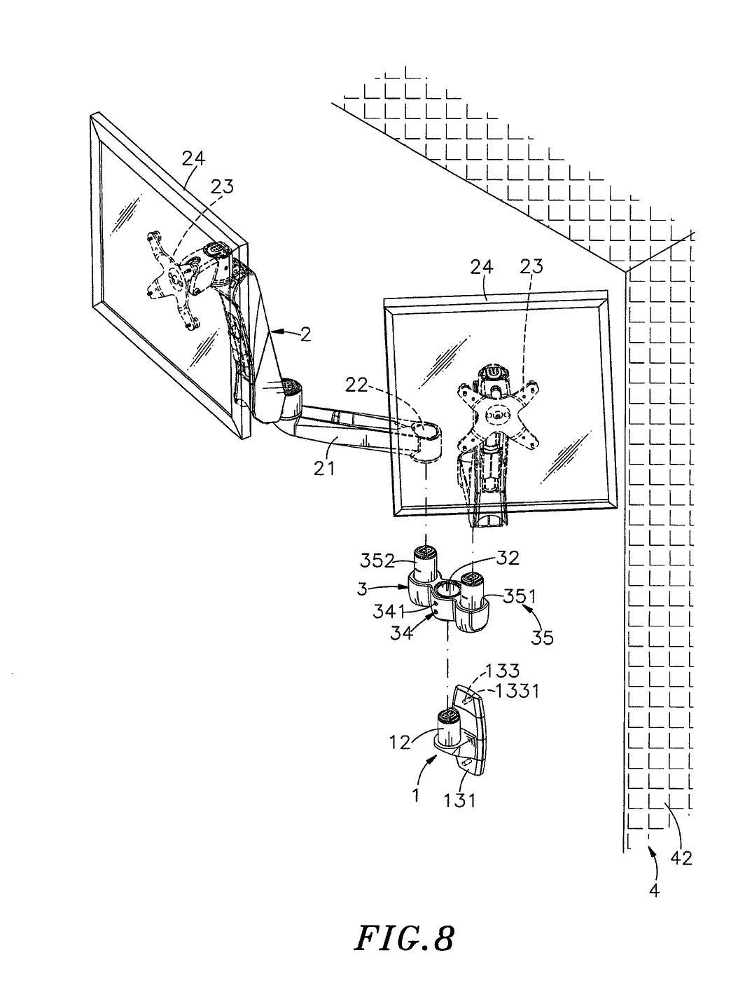

Referring to FIG. 8, in still another alternate form of the present invention, the mounting device 13 comprises a mounting plate 131 fixedly connected to or formed integral with the (tubular mounting base) of the mounting unit 1, and a plurality of fastening members, for example, screw nails 1331 respectively inserted through respective mounting through holes 133 on the mounting plate 131 and driven into a wall 42 of an object 4.

As stated above, one or multiple support holders 3 can be coupled to the upright rod 12 of the mounting unit 1 and adjustably locked to the upright rod 12 of the mounting unit 1 at the desired elevation to hold multiple screen supports 2 and a screen 24 (LCD monitor or LCD TV) at each screen support 2. By means of driving the holding-down members 34 (hexagonal tubular mounting base screws 341) into the screw holes 313 to hold down the friction pad 33 against the bush 32 and the upright rod 12 of the mounting unit 1, the support holder 3 is locked to the upright rod 12 of the mounting unit 1. When loosened the holding-down members 34 (hexagonal tubular mounting base screws 341), the support holder 3 can be moved axially along the upright rod 12 of the mounting unit 1 to the desired elevation. Further, the friction pad 33 and the bush 32 can be omitted. In this case, the holding-down members 34 (hexagonal tubular mounting base screws 341) can be directly driven into the screw holes 313 and stopped against the periphery of the upright rod 12 of the mounting unit 1 to lock the support holder 3 to the upright rod 12 of the mounting unit 1. Subject to the modularized design of the present invention, the user can adjust the number of the screen supports 2 conveniently subject to the number of screens 24 to be supported.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. An adjustable multi-screen support structure, comprising:
a mounting unit, said mounting unit comprising a tubular mounting base, an upright rod vertically mounted in said tubular mounting base, and a mounting device located on a bottom side of said tubular mounting base for fastening to an external object;
a plurality of screen supports for supporting a respective screen, each said screen support comprising at least one support arm, a coupling sleeve located on one end of said at least one support arm and a bracket located on an opposite end of said at least one support arm for holding a screen; and
a support holder mounted on said upright rod of said mounting unit to hold said screen supports, said support holder comprising a tubular holder base sleeved onto said upright rod of said mounting unit, at least one screw hole located on said tubular holder base, at least one holding-down member respectively fastened to said at least one screw hole on said tubular holder base and stopped for locking said tubular holder base to said upright rod of said mounting unit, and a plurality of stepped shaft members fixedly connected to the periphery of said tubular holder base for holding the coupling sleeves of said screen supports respectively.

2. The adjustable multi-screen support structure as claimed in claim 1, wherein said mounting device comprises a screw rod axially downwardly extended from said tubular mounting base, and a mounting plate threaded onto said screw rod, said mounting plate having a top clamping wall that defines with said tubular mounting base a clamping space, and a bottom knob operable by a user to rotate said mounting plate relative to said screw rod.

3. The adjustable multi-screen support structure as claimed in claim 1, wherein said mounting device comprises a mounting plate made in the form of a substantially L-shaped mounting shaft and fixedly connected to said tubular mounting base of said mounting unit, and a screw rod made in the form of a tension clamp and threaded through a bottom wall of said mounting plate, said screw rod having a head located on a bottom end thereof and suspending below said mounting plate and a flat block located on a top end thereof and suspending in said mounting plate.

4. The adjustable multi-screen support structure as claimed in claim 1, wherein said mounting device comprises a mounting plate fixedly connected to said tubular mounting base of said mounting unit, said mounting plate having a plurality of mounting through holes, and a plurality of fastening members respectively inserted through the mounting through holes of said mounting plate and fastenable to an external object to affix said mounting plate to the external object.

5. The adjustable multi-screen support structure as claimed in claim 1, wherein said support holder further comprises a bush inserted into said tubular holder base, and a friction pad inserted into said tubular holder base and stopped between said bush and said tubular holder base corresponding to said at least one mounting through hole on said tubular holder base for stopping the periphery of said bush against the periphery of said upright rod of said mounting unit by said least one holding-down member.

6. The adjustable multi-screen support structure as claimed in claim 5, wherein said tubular holder base has a locating groove located on an inside wall thereof corresponding to said at least one mounting through hole for accommodating said friction pad, and a positioning groove located on a bottom side thereof; said bush is upwardly inserted into said tubular holder base, having a bottom flange extending around the periphery thereof and engaged into said positioning groove.

7. The adjustable multi-screen support structure as claimed in claim 1, wherein each said stepped shaft member comprises a shank disposed at a top side thereof and inserted through the sleeve of one said screen support.

8. The adjustable multi-screen support structure as claimed in claim 1, wherein each said stepped shaft member comprises a cup-shaped shell formed integral with the periphery of said tubular holder base and adapted for supporting the coupling sleeve of one said screen support, and a shank mounted in said cup-shaped shell inserted through the sleeve of one said screen support.
